(19) United States
(12) Patent Application Publication
(10) Pub. No.: US 2020/0011655 A1
(43) Pub. Date: Jan. 9, 2020

(54) MARKER MOUNTING UNIT

(71) Applicant: ENPLAS CORPORATION, Kawaguchi-shi, Saitama (JP)

(72) Inventors: Yasuyuki FUKUDA, Saitama (JP); Ryo SASAKI, Saitama (JP)

(21) Appl. No.: 16/489,968

(22) PCT Filed: Feb. 15, 2018
(86) PCT No.: PCT/JP2018/005333

§ 371 Date: Aug. 29, 2019

(30) Foreign Application Priority Data
Mar. 1, 2017 (JP) 2017-037956

(51) Int. Cl. G01B 11/14; G01B 11/26; G06T 7/70

(52) U.S. Cl. CPC G01B 11/14; G01B 11/02; G06T 7/70; G01B 11/26

(57) ABSTRACT

The present invention provides a marker mounting unit for mounting, for example, a marker such as a RAS marker, that has a detection reference portion accurately detectable. The marker mounting unit of the present invention includes: a lower substrate; and an upper substrate, wherein the marker mounting unit is a laminate in which the upper substrate is laminated on the lower substrate, the lower substrate has a bump serving as a detection reference portion, the upper substrate has a through hole at a position corresponding to the bump of the lower substrate, the bump of the lower substrate is inserted into the through hole of the upper substrate, and the upper substrate has a relative transmittance of 99% or less at least at a periphery of the through hole on at least one surface.

### TECHNICAL FIELD

The present invention relates to a marker mounting unit.

### BACKGROUND ART

In the fields of augmented reality (also referred to as “AR” hereinafter), robotics, etc., a so-called visual marker is used to recognize the position, the orientation, and the like of an object. As the marker, for example, an AR marker is commonly used. As another example of the marker, for example, a marker that includes a lenticular lens arranged on a black stripe pattern has been reported (Patent Literature 1). The marker is commonly referred to as a rotation angle scale marker (RAS marker). When an image appearing on the marker is detected by a detection device such as a camera, the color gradation pattern of the image changes depending on the viewing angle of the camera with respect to the marker. Thus, the rotation angle of the marker can be determined by detecting the color gradation pattern of the marker.

The visual marker is usually arranged on a substrate, and a plurality of detection reference portions serving as marks of regions to be detected by the camera are provided on the substrate, and such a substrate is used as a marker unit. An example of the marker unit is shown in FIGS. 7A and 7B. FIGS. 7A and 7B show schematic views of a marker unit 5 on which a RAS marker is mounted. FIG. 7A is a top view and FIG. 7B is a cross-sectional view taken along the line V-V of FIG. 7A.

A marker unit 5 includes a lower substrate 41 having a black upper surface, an interposed substrate 42 having a white upper surface, a transparent upper substrate 40, and a RAS marker 43. The interposed substrate 42 is disposed on the lower substrate 41, and the upper substrate 40 and the RAS marker 43 are disposed on the interposed substrate 42. The interposed substrate 42 and the upper substrate 40 have circular through holes at positions corresponding to each other, and a circular detection reference portion 412 is formed by exposing the black upper surface of the lower substrate 41. In the upper substrate 40, a RAS marker 43 is disposed between adjacent detection reference portions 412.

### CITATION LIST

### Patent Literature

Patent Literature 1: JP 2012-145559 A

### SUMMARY OF INVENTION

### Technical Problem

As a precondition for detecting an image 431 of the RAS marker 43 in the marker unit 5, it is important to accurately detect the detection reference portion 412. However, there is a problem of the detection accuracy being insufficient.

With the foregoing in mind, it is an object of the present invention to provide a marker mounting unit for mounting, for example, a marker such as a RAS marker, that has a detection reference portion accurately detectable.

### Solution to Problem

In order to achieve the above object, the present invention provides a marker mounting unit including: a lower substrate; and an upper substrate, wherein the marker mounting unit is a laminate in which the upper substrate is laminated on the lower substrate, the lower substrate has a bump serving as a detection reference portion, the upper substrate has a through hole at a position corresponding to the bump of the lower substrate, the bump of the lower substrate is inserted into the through hole of the upper substrate, and the upper substrate has a relative transmittance of 99% or less at least at a periphery of the through hole on at least one surface.

### Advantageous Effects of Invention

According to the marker mounting unit of the present invention, the detection reference portion can be accurately detected by setting the relative transmittance at the periphery of the through hole of the upper substrate on at least one surface as described above.

### BRIEF DESCRIPTION OF DRAWINGS

FIG. 1A is a top view showing an example of the marker mounting unit according to the first embodiment. FIG. 1B is a cross-sectional view of the marker mounting unit taken along the line I-I of FIG. 1A.

FIG. 2 is a top view showing a variation of the marker mounting unit according to the first embodiment.

FIG. 3 is a cross-sectional view showing an example of the marker mounting unit according to the second embodiment.

FIG. 4 is a cross-sectional view showing an example of the marker mounting unit according to the third embodiment.

FIG. 5A is a top view showing an example of the marker unit according to the fourth embodiment. FIG. 5B is a cross-sectional view of the marker unit taken along the line II-II of FIG. 5A. FIG. 5C is a top view showing a variation of the marker unit according to the fourth embodiment. FIG. 5D is a cross-sectional view of the marker unit taken along the line of FIG. 5C.

FIG. 6A is a plan view showing an example of the marker mounting unit according to the fifth embodiment. FIG. 6B is a cross-sectional view of the marker unit taken along the line IV-IV of FIG. 6A.

FIG. 7A is a top view showing an example of a conventional marker unit. FIG. 7B is a cross-sectional view of the marker unit taken along the line V-V of FIG. 7A.

FIG. 8 is a cross-sectional view showing an example of a reference marker unit.

FIG. 9A shows photographs (raw images) of marker units of examples and a comparative example taken at a predetermined angle, and FIG. 9B shows images obtained by binarizing the photographs of FIG. 9A.

### DESCRIPTION OF EMBODIMENTS

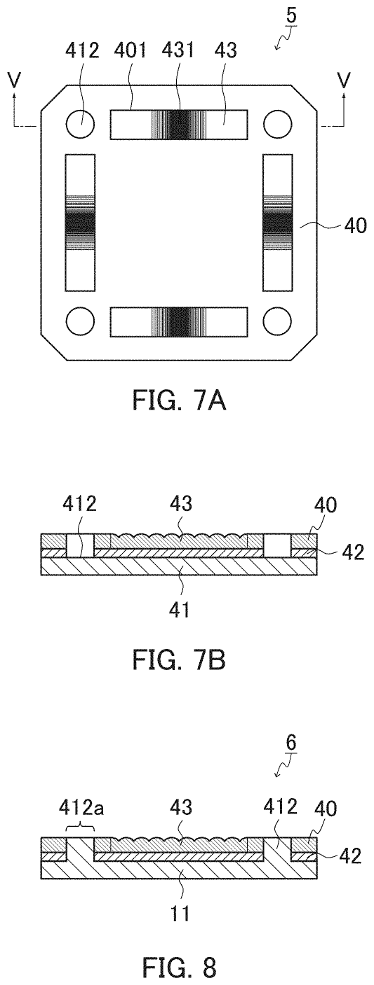

The inventors of the present invention have intensively studied the issue of the detection accuracy of the detection reference portion 412 in the conventional marker unit 5 shown in FIGS. 7A and 7B being insufficient. As a result, the inventors have found that, when the surface of the upper substrate 40 is set to a reference, the surface of the lower substrate 41 having the detection reference portion 412 is positioned significantly lower than the reference in the marker unit 5, which affects the detection accuracy. Thus, as shown in FIG. 8, the inventors have come to find an aspect in which the bump 412 is provided on the lower substrate 11, the upper surface 412a of the bump 412 is used as the detection reference portion, and the bump 412 of the lower substrate 11 is inserted into the through hole of the upper substrate 40. According to the marker mounting unit 6 of this aspect, for example, the upper surface of the upper substrate 40 becomes the upper surface of the marker 43. Thus, the upper surface of the marker 43 (the upper surface of the upper substrate 40) and the detection reference portion 412a (the upper surface of the bump 412) are positioned closer to each other. Therefore, the distance between the detection device such as a camera and the marker 43 and the distance between the detection device and the detection reference portion 412a become closer to each other, whereby the detection condition of the marker and the detection condition of the detection reference portion by the detection device become closer to each other. Therefore, as a result, the axial deviation of the rotation shaft is improved, and the detection accuracy of the detection reference portion can be improved.

However, in the marker mounting unit, even if the bump is provided on the lower substrate, further improvement in detection accuracy is desired. Hence, the inventors of the present invention conducted further studies. As a result, the following findings were obtained. That is, in the detection of the detection reference portion 412a in the marker unit 6, first, the marker unit 6 is photographed, then, the raw image thereof is subjected to binarization processing, i.e., image processing for replacing the actual color with white and black of multiple gradations (e.g., 128 gradations, 256 gradations, etc.), and the detection reference portion 412a is analyzed based on the thus obtained processed binarized image. However, in the marker unit 6, the detection reference portion 412a is the surface of the bump 412 of the lower substrate 11, and a shadow may be caused due to the bump 412 depending on the detection angle of the detection device. Then, in a case where a shadow is photographed in the raw image, when the raw image is subjected to multiple-gradation image processing, the shadow and the detection reference portion 412a are together represented in black in the binarized image. In this case, the detection reference portion 412a in the binarized image is different from the actual one. For example, the shape of the detection reference portion 412a is distorted, the size is increased, or the center is deviated. In such a case, analysis is performed based on the binarized image showing the detection reference portion 412a that is different from the actual one, and this may decrease the detection accuracy. Based on this finding, the inventors of the present invention have conceived the idea of setting the relative transmittance of the upper substrate to the above-mentioned conditions. According to the marker mounting unit of the present invention, it is possible to suppress the shadows caused by the bump of the lower substrate, thereby preventing distortion of the shape and deviation of the center in the binarized image, and consequently, to improve the detection accuracy of the detection reference portion.

In the marker mounting unit of the present invention, for example, the upper substrate is a transparent substrate in which at least the periphery of the through hole is roughened at least on one surface.

In the marker mounting unit of the present invention, for example, the upper substrate is a transparent substrate in which at least the periphery of the through hole is roughened on both surfaces.

In the marker mounting unit of the present invention, for example, the upper substrate has a relative transmittance of 30% or less at least at the periphery of the through hole on at least one surface.

In the marker mounting unit of the present invention, for example, the upper substrate is a transparent substrate having a white film at least at the periphery of the through hole on at least one surface.

In the marker mounting unit of the present invention, for example, the upper substrate is a transparent substrate having a white film at least at the periphery of the through hole on both surfaces.

In the marker mounting unit of the present invention, for example, the bump of the lower substrate has a black upper surface.

In the marker mounting unit of the present invention, for example, the laminate further includes an interposed substrate, with the lower substrate, the interposed substrate, and the upper substrate laminated in this order, the interposed substrate is a substrate having a through hole at a position corresponding to the bump of the lower substrate, and the bump of the lower substrate is inserted into the through hole of the interposed substrate and the through hole of the upper substrate.

In the marker mounting unit of the present invention, for example, the laminate further includes an interposed substrate, the lower substrate, the interposed substrate, and the upper substrate are laminated in this order, the interposed substrate is a substrate having a through hole at a position corresponding to the bump of the lower substrate and having a cylindrical portion protruding upward at the periphery of the through hole, the through hole on the upper substrate corresponds to the bump of the lower substrate and the cylindrical portion of the interposed substrate, the bump of the lower substrate is inserted into a through hole in the cylindrical portion of the interposed substrate, and the cylindrical portion of the interposed substrate is inserted into the through hole of the upper substrate.

In the marker mounting unit of the present invention, for example, the interposed substrate has a white upper surface.

Next, the present invention will be described in detail. The present invention, however, is in no way limited to the following examples. Hereinafter, in the laminate of the marker mounting unit, the lower substrate side is referred to as a downward direction, and the upper substrate side is referred to as an upward direction.

The lower substrate of the present invention has a bump serving as a detection reference portion. The shape of the plane of the bump (for example, the cross section in the planar direction of the bump, specifically, the upper surface of the bump) is not particularly limited, and may be, for example, a circular shape, a polygonal shape, or the like. Examples of the circular shape include a perfect circle and an ellipse, and a perfect circle is preferable. The polygonal shape may be, for example, a polygon such as a triangle or a quadrilateral, and the examples of the quadrilateral include a square and a rectangle. The size of the plane of the bump is not particularly limited, and in the case of a circle, the diameter thereof is, for example, 1 to 25 mm, and in the case of a shape other than a circle, the area thereof can be, for example, an area obtained from the condition of the diameter of the circle.

The shape of the bump is, for example, a columnar shape having the same cross section as the upper surface, and is, for example, a cylindrical columnar shape, a polygonal columnar shape, or the like. The height of the bump is not particularly limited, and is, for example, 0.4 to 10 mm.

In the lower substrate, the number and position of the detection reference portions are not particularly limited, and may be any number and any position as long as, when a marker is mounted on the marker mounting unit of the present invention, they are appropriate for being marks of the region to be detected by the camera, for example.

The color of the lower substrate is not particularly limited, and may be a color with which the upper surface of the bump can be distinguished from the periphery thereof when viewed from the upper surface side of the laminate, for example. In the lower substrate, only the upper surface of the bump may be a color which can be distinguished from the periphery thereof, or the entire bump may be a color which can be distinguished from the periphery thereof, for example. The color is, for example, black. The lower substrate may be, for example, a substrate made of black resin. The black resin can be prepared, for example, by adding a black colorant to a transparent resin. The colorant may be, for example, a masterbatch, a dry color, or the like. Examples of the transparent resin include polycarbonate (PC), acrylic resin (e.g., polymethyl methacrylate (PMMA)), cycloolefin polymer (COP), and cycloolefin copolymer (COC).

In the upper substrate of the present invention, as described above, the relative transmittance at least at the periphery of the through hole on at least one surface is only required to be 99% or less.

The upper limit of the relative transmittance is, for example, 99% or less, 98% or less, 80% or less, or 30% or less. The lower limit of the relative transmittance is not particularly limited, and may be, for example, 1% or more, 5% or more, or 10% or more, or light may substantially not be allowed to pass through (relative transmittance of 0%).

In the upper substrate, the relative transmittance may be satisfied by either surface. That is, both the lower surface in the lower direction and the upper surface in the upper direction of the upper substrate may satisfy the relative transmittance, or either surface may satisfy the relative transmittance, for example. Here, the “relative transmittance of the surface” is a relative transmittance when light is emitted from either surface side.

In the present invention, the “relative transmittance” means the relative value (%) of the measured transmittance of the upper substrate at a wavelength of 550 nm when the measured transmittance of the following reference sample at a wavelength of 550 nm is set to 100%. The reference sample is a polycarbonate plate (product name: Iupilon S-3000R, Mitsubishi Engineering-Plastics Corporation) having a thickness of 0.8 mm and both surfaces thereof being smooth (mirror surface).

The method for calculating the relative transmittance is as follows, for example. First, a sample (the reference sample or the upper substrate) is disposed between the light source of the spectrophotometer and the integrating sphere, the sample is irradiated with light in the visible light region while wavelength sweeping, and the amount of received light of each wavelength is detected by a detector in the integrating sphere. Among the detected light, the transmittance of light at a wavelength of 550 nm is obtained as the measured transmittance. Then, the measured transmittance of the reference sample at a wavelength of 550 nm is set to 100%, the relative value of measured transmittance of the upper substrate at a wavelength of 550 nm with respect to the measured transmittance is obtained, and this is set as the relative transmittance of the upper substrate. The upper substrate is used alone for detecting the amount of light of the upper substrate. In the upper substrate, the relative transmittance calculated on the basis of that of the upper substrate on at least one surface is only required to satisfy the aforementioned condition.

In the upper substrate, it is only required that at least the periphery of the through hole of the upper substrate on either surface satisfies the aforementioned relative transmittance. In the upper substrate, the region X satisfying the relative transmittance is not particularly limited, and, for example, when the distance from the center of the detection reference portion to the outer periphery on the upper surface of the laminate is set to a relative value 1, the relative value of the distance X from the center of the detection reference portion to the outer periphery of the region X is, for example, 1.2, 2, or 5. Specifically, for example, when the detection reference portion is circular and the radius thereof is 0.5 to 12.5 mm, the distance from the center of the detection reference portion to the outer periphery of the region X is 0.6 to 62.5 mm. The upper substrate may satisfy the relative transmittance, for example, on either surface except for a region where a marker is mounted.

In the upper substrate, a predetermined region X is only required to satisfy the relative transmittance, and the aspect of the region X exhibiting the relative transmittance is not particularly limited.

The upper substrate may be, for example, a resin substrate satisfying the relative transmittance, or may be prepared from a resin substrate not satisfying the relative transmittance. The former substrate may be, for example, a resin substrate made of acrylonitrile-butadiene-styrene copolymer synthetic resin (ABS), polyethylene terephthalate (PET), polystyrene (PS), or the like. As the latter substrate, for example, a transparent substrate can be used, and the transparent substrate may be the one not satisfy the relative transmittance. The transparent substrate may be, for example, a transparent resin substrate made of polycarbonate (PC), an acrylic resin (e.g., polymethyl methacrylate (PMMA)), a cycloolefin polymer (COP), a cycloolefin copolymer (COC), or the like.

In the case of the transparent substrate, for example, the upper substrate can be obtained by performing a process of decreasing the transmittance originally possessed by the transparent substrate to the relative transmittance. For example, by roughening a desired region of the transparent substrate, an upper substrate having a roughened region X satisfying the relative transmittance can be obtained. The roughening treatment is not particularly limited, and examples thereof include blasting, electric discharge machining, etching, and laser machining.

In addition, by forming a film satisfying the relative transmittance in a desired region of the transparent substrate, an upper substrate having the film satisfying the relative transmittance can be obtained, for example. Examples of the film include a printing film, a coating film, and a seal. Examples of the method for forming the printing film include screen printing, silk printing, relief printing, intaglio printing, and offset printing. The method for forming the coating film may be, for example, coating by spraying or the like. As to the seal, for example, a film having an adhesive layer can be used, and, by laminating the film on the desired region of the transparent substrate through the adhesive layer, the upper substrate can be obtained. The film may be, for example, a resin film, paper, or the like, and the adhesive layer may be, for example, a double-sided tape.

The color of the film is not particularly limited, and a color having a large contrast with the upper surface of the bump of the lower substrate is preferable. When the color of the upper surface of the bump of the lower substrate is black, the color of the film of the lower substrate is preferably white, for example.

The through hole of the upper substrate has, for example, substantially the same shape as the bump of the lower substrate, and the hole area of the through hole of the upper substrate is, for example, substantially the same area as the area of the plane of the bump of the lower substrate (for example, the cross section in the planar direction, specifically, the upper surface of the bump).

In the marker mounting unit of the present invention, the aspect of the laminate is not particularly limited as long as a predetermined region of the upper substrate in the laminate satisfies the relative transmittance. The aspect of the laminate will be exemplified below. The present invention, however, is not limited thereto.

### First Embodiment

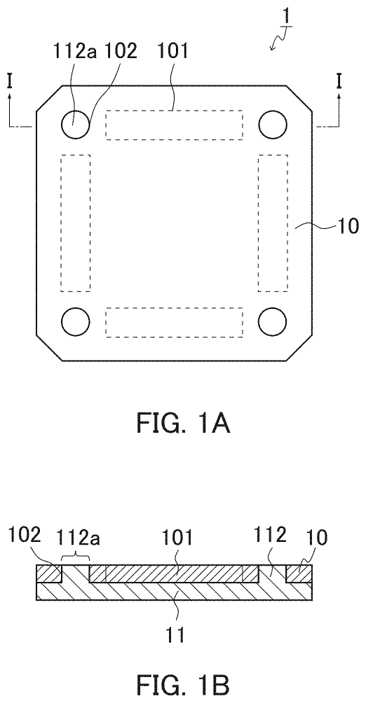

The first embodiment relates to an example of a marker mounting unit according to the present invention. FIGS. 1A and 1B show an example of a marker mounting unit of the present embodiment, which is composed of a two-layer substrate. FIG. 1A is a plan view of the marker mounting unit 1, and FIG. 1B is a cross-sectional view of the marker mounting unit 1 taken along the line I-I of FIG. 1A.

As shown in FIGS. 1A and 1B, the marker mounting unit 1 includes a lower substrate 11 and an upper substrate 10, and is a laminate in which the upper substrate 10 is laminated on the lower substrate 11. The lower substrate 11 has columnar bumps 112 at four corners, and the upper surface of the bump 112 serves as a detection reference portion 112a. The upper substrate 10 has circular through holes 102 at positions corresponding to the bumps 112 of the lower substrate 11. The upper substrate 10 has, for example, marker arrangement regions 101, each placed between two circular through holes 102. The marker arrangement region 101 surrounded by the dotted line is a region to serve as a marker such as a RAS marker, for example, and the upper surface of the marker arrangement region 101 on the upper substrate 10 also serves as the upper surface of the marker, for example.

The method for mounting the marker on the marker mounting unit 1 is not particularly limited, and for example, when the marker is a RAS marker or the like, the marker arrangement region 101 of the upper substrate 10 can serve as a marker such as a RAS marker by forming a detectable portion such as a black stripe pattern on the lower surface of the upper substrate 10 in a region corresponding to the marker arrangement region 101. In the present invention, the term “marker arrangement” includes an aspect in which a physically independent marker is placed on the marker mounting unit and an aspect in which the function of a marker such as a RAS marker is given to a predetermined region of a component of the marker mounting unit to serve as a marker.

In the present invention, “the bump is inserted into the through hole” denotes a positional relationship between the through hole and the bump. For example, the present invention is not limited to an aspect in which the upper substrate having the through hole and the lower substrate having the bump are provided separately, and the bump of the lower substrate is inserted into the through hole of the upper substrate. The present invention may include an aspect in which the material of the one substrate is molded in a state of close contact with the other substrate.

In the marker mounting unit 1, the positional relationship between the upper surface 112a of the bump 112 of the lower substrate 11 and the upper surface of the upper substrate 10 is not particularly limited. The upper surface 112a of the bump 112 of the lower substrate 11 may be, for example, at a flat position with respect to the upper surface of the upper substrate 10, or may be at a lower position or at a higher position with respect to the upper surface of the upper substrate 10. In the former case, there is no step between the upper surface 112a of the bump 112 of the lower substrate 11 and the upper surface of the upper substrate 10, and in the latter case, there is a step between the upper surface 112a of the bump 112 of the lower substrate 11 and the upper surface of the upper substrate 10. The difference in height between the upper surface 112a of the bump 112 of the lower substrate 11 and the upper surface of the upper substrate 10 is not particularly limited. In the entire marker mounting unit 1, when the height to the upper surface of the upper substrate 10 is set to 1 with reference to the lower surface of the upper substrate 10, the relative value of the height from the reference to the upper surface 112a of the bump 112 of the lower substrate 11 is, for example, 0.8 to 1.2.

In the lower substrate 11, the number and position of the detection reference portions 112a (bumps 112) are not particularly limited, and may be any number and any position as long as, when a marker (not shown) is mounted on the marker mounting unit 1, they are appropriate for being marks of the region to be detected by the camera, for example. In the marker mounting unit 1 shown in FIGS. 1A and 1B, the number of the detection reference portions 112a is four, and the detection reference portions 112a are positioned, for example, in the vicinity of each end in the longitudinal direction of the marker arrangement region 101.

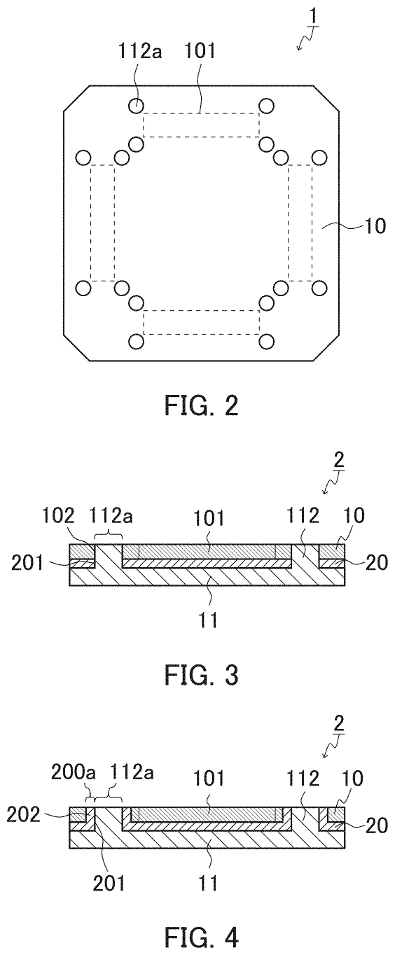

In the present invention, the number and position of the detection reference portions 112a are not limited to this example. Another example of the detection reference portion 112a in the marker mounting unit of the present invention is shown in the top view of FIG. 2. As shown in FIG. 2, the marker mounting unit 1 may have, for example, four detection reference portions 112a for one marker arrangement area 101.

In the upper substrate 10, the shape, number, and position of the marker arrangement region 101 on which the marker is to be mounted are not particularly limited, and can be appropriately determined depending on the shape, number, and position of the marker to be mounted on the marker mounting unit 1.

### Second Embodiment

The second embodiment relates to another example of the marker mounting unit according to the present invention. FIG. 3 shows an example of the marker mounting unit of the present embodiment, which is composed of a three-layer substrate. FIG. 3 is a cross-sectional view of the marker mounting unit 2. In the present embodiment, reference can be made to the description of the first embodiment, unless otherwise stated.

As shown in FIG. 3, the marker mounting unit 2 includes the lower substrate 11, the upper substrate 10, and an interposed substrate 20. The marker mounting unit 2 is a laminate in which the upper substrate 10 is laminated on the lower substrate 11 with the interposed substrate 20 interposed therebetween. Like the upper substrate 10, the interposed substrate 20 has circular through holes 201 at positions corresponding to the bumps 112 of the lower substrate 11. In the laminate, the bump 112 of the lower substrate 11 is inserted into the circular through hole 201 of the interposed substrate 20 and the circular through hole 102 of the upper substrate 10.

It is preferable that the bump 112 of the lower substrate 11 and the through hole 201 of the interposed substrate 20 have substantially the same shape, for example, and that the area of the plane of the former (for example, the cross section in the planar direction, specifically, the upper surface 112a) and the hole area of the through hole 201 of the latter be substantially the same. “The areas are substantially the same” means, for example, that the area of the plane of the bump 112 is in the range from 0.8 to 1 times as large as the hole area of the through hole 201.

The interposed substrate 20 has the through holes 201 at positions corresponding to the bumps 112 of the lower substrate 11. The shape of the through hole 201 is not particularly limited, and may be, for example, the same shape as the bump 112, and specific examples thereof include a circular shape and a polygonal shape.

In the interposed substrate 20, the number and position of the through holes 201 are not particularly limited, and since the through holes 201 correspond to the bumps 112 of the lower substrate 11, reference can be made to the description for the bump 112 in the first embodiment.

In the marker mounting unit 2, the interposed substrate 20 is, for example, a reflective substrate. For example, the upper surface of the interposed substrate 20 may be white or the entire interposed substrate 20 may be white.

### Third Embodiment

The third embodiment relates to another example of the marker mounting unit of the present invention, in which the interposed substrate has a cylindrical portion. FIG. 4 shows an example of the marker mounting unit of the present embodiment. FIG. 4 is a cross-sectional view of the marker mounting unit 2. In the present embodiment, reference can be made to the description of the first and second embodiments, unless otherwise stated.

As shown in FIG. 4, the marker mounting unit 2 includes the lower substrate 11 and the interposed substrate 20. The marker mounting unit 2 is a laminate in which the upper substrate 10 is further laminated on the interposed substrate 20. The interposed substrate 20 has circular through holes 201 at positions corresponding to the bumps 112 of the lower substrate 11, and has cylindrical portions 202 protruding upward at the periphery of the through holes 201. The upper substrate 10 has circular through holes at positions corresponding to the cylindrical portions 202 of the interposed substrate 20. In the laminate, the bump 112 of the lower substrate 11 is inserted into the through hole 201 in the cylindrical portion 202 of the interposed substrate 20. In the laminate, the cylindrical portion 202 of the interposed substrate 20 is inserted into the through hole of the upper substrate 10.

In the marker mounting unit 2, the positional relationship between the upper surface 112a of the bump 112 of the lower substrate 11 and the upper surface of the upper substrate 10 is not particularly limited. The upper surface 112a of the bump 112 of the lower substrate 11 may be, for example, at a flat position with respect to the upper surface of the upper substrate 10, or may be at a lower position or at a higher position with respect to the upper surface of the upper substrate 10. In the former case, there is no step between the upper surface 112a of the bump 112 of the lower substrate 11 and the upper surface of the upper substrate 10, and in the latter case, there is a step between the upper surface 112a of the bump 112 of the lower substrate 11 and the upper surface of the upper substrate 10. The difference in height between the upper surface 112a of the bump 112 of the lower substrate 11 and the upper surface of the upper substrate 10 is not particularly limited. In the entire marker mounting unit 2, when the height to the upper surface of the upper substrate 10 is set to 1 with reference to the lower surface of the interposed substrate 20, the relative value of the height from the reference to the upper surface 112a of the bump 112 of the lower substrate 11 is, for example, 0.8 to 1.2.

In the marker mounting unit 2, the positional relationship between the upper surface 112a of the bump 112 of the lower substrate 11 and the upper surface 200a of the cylindrical portion 202 of the interposed substrate 20 is not particularly limited. The upper surface 112a of the bump 112 of the lower substrate 11 may be, for example, at a flat position with respect to the upper surface 200a of the cylindrical portion 202 of the interposed substrate 20, or may be at a lower position or at a higher position with respect to the upper surface 200a of the cylindrical portion 202 of the interposed substrate 20. In the former case, there is no step between the upper surface 112a of the bump 112 of the lower substrate 11 and the upper surface 200a of the cylindrical portion 202 of the interposed substrate 20, and in the latter case, there is a step between the upper surface 112a of the bump 112 of the lower substrate 11 and the upper surface 200a of the cylindrical portion 202 of the interposed substrate 20. The difference in height between the upper surface 112a of the bump 112 of the lower substrate 11 and the upper surface 200a of the cylindrical portion 202 of the interposed substrate 20 is not particularly limited. In the entire marker mounting unit 2, when the height to the upper surface 200a of the cylindrical portion 202 of the interposed substrate 20 is set to 1 with reference to the lower surface of the interposed substrate 20, the relative value of the height from the reference to the upper surface 112a of the bump 112 of the lower substrate 11 is, for example, 0.8 to 1.2.

It is preferable that the bump 112 of the lower substrate 11 and the inside of the cylindrical portion 202 of the interposed substrate 20 have substantially the same shape, for example, and that the area of the plane of the former (for example, the cross section of the bump 112 in the planar direction, specifically, the upper surface 112a) and the area of the plane of the internal space of the latter (for example, the cross section of the internal space of the cylindrical portion 202 in the planar direction) be substantially the same. “The areas are substantially the same” means, for example, that the area of the plane of the bump 112 is in the range from 0.8 to 1 times as large as the area of the plane of the internal space of the cylindrical portion 202.

It is preferable that the cylindrical portion 202 of the interposed substrate 20 and the inside of the through hole of the upper substrate 10 have substantially the same shape, for example, and that the area of the plane surrounded by the outer periphery of the former (the cylindrical portion 202 of the interposed substrate 20) and the area of the plane of the internal space of the latter (for example, the cross section of the internal space of the through hole of the upper substrate 10 in the planar direction) be substantially the same. “The areas are substantially the same” means, for example, that the area of the plane of the cylindrical portion 202 of the interposed substrate 20 is in the range from 0.8 to 1 times as large as the area of the plane of the internal space of the through hole of the upper substrate 10.

The shape of the cylindrical portion 202 of the interposed substrate 20 is not particularly limited, and, for example, the inside thereof has the same shape as the bump 112. The shape of the cylindrical portion 202 is, for example, a hollow circular cylindrical shape, a hollow polygonal cylindrical shape, or the like. The inner wall of the cylindrical portion 202 may be perpendicular or tapered with respect to the planar direction, for example. In the latter case, the inner wall of the cylindrical portion 202 widens as it extends from the top to the bottom.

In the marker mounting unit 2, the interposed substrate 20 is, for example, a reflective substrate. For example, the upper surface of the interposed substrate 20 may be white or the entire interposed substrate 20 may be white.

### Fourth Embodiment

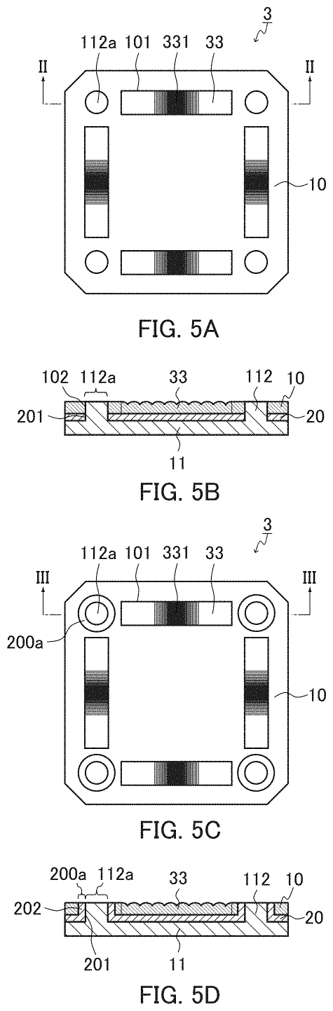

The fourth embodiment relates to an example of the marker mounting unit further including a marker. Since the present embodiment includes the marker, it is also referred to as an example of a marker unit. FIGS. 5A to 5D show an example of the marker unit of the present embodiment. FIGS. 5A and 5B are schematic diagrams of a marker unit 3 in which a marker 33 is mounted on the marker mounting unit 2 of FIG. 3, FIG. 5A is a top view of the marker unit 3, and FIG. 5B is a cross-sectional view of the marker unit 3 taken along the line II-II of FIG. 5A. In the present embodiment, reference can be made to the description of the first to third embodiments, unless otherwise stated.

As shown in FIGS. 5A and 5B, in the marker unit 3, the marker 33 is arranged on the interposed substrate 20 and in the marker arrangement region 101 of the upper substrate 10 of the marker mounting unit 2 of FIG. 3. The marker mounting unit of the present invention and the marker unit of the present invention are characterized by the configuration of the detection reference portion, and the type of a marker to be mounted is not limited in any way. In the present embodiment, a so-called RAS marker using a lenticular lens is described as an example. The present invention, however, is not limited thereto, and other two-dimensional pattern codes and the like may be used. The two-dimensional pattern code is not particularly limited, and examples thereof include an AR marker and a QR marker. Examples of the AR marker include an ARToolKit, an ARTag, a CyberCode, and an ARToolKitPlus.

Furthermore, the marker mounting unit of the present invention and the marker unit of the present invention are characterized by the configuration of the detection reference portion as described above, and the position where the marker is mounted is not limited at all. For example, in FIG. 5A, when the marker is mounted at the center, for example, the upper substrate 10 may have the marker arrangement region at a corresponding position, and the marker may be mounted in the marker arrangement region.

In the marker mounting unit of the present invention and the marker unit of the present invention, for example, the upper surface of the marker arrangement region of the upper substrate also serves as the upper surface of the marker. In the case where the marker is, for example, a RAS marker or the like, the upper substrate, the lower substrate, and optionally the interposed substrate are arranged as described above in a state where the detectable portion (e.g., a detectable stripe pattern, a dot pattern, or the like) of the marker is formed on the lower surface of the upper substrate in a region corresponding to the marker arrangement region. As a result, the position of the upper substrate corresponding to the marker arrangement region serves as the marker in the marker unit of the present invention. It is to be noted that the present invention is not limited thereto. For example, the marker arrangement region of the upper substrate may be a through hole, and in the marker mounting unit, a separately prepared marker may be arranged on the lower substrate or optionally on the interposed substrate at a position corresponding to the marker arrangement region. In this case, it is preferable that the upper surface of the marker be positioned at a level equivalent to the upper surface of the bump serving as the detection reference portion, for example.

An example of the marker 33 shown in FIGS. 5A to 5D is described below. In the present invention, the marker is not limited to the following description.

The marker 33 includes a lens main body having a plurality of lens units, and the plurality of lens units are arranged continuously in the planar direction. A direction in which the lens units are arranged is referred to as an arrangement direction or a width direction, and a direction perpendicular to the arrangement direction in the planar direction is referred to as a length direction.

The lens unit in the lens main body may be, for example, a cylindrical lens. The lens main body is, for example, a light-transmitting member. The light-transmitting member is not particularly limited, and may be formed of a resin, glass, or the like, for example. Examples of the resin include polycarbonate, acrylic resin (e.g., polymethyl methacrylate (PMMA)), cycloolefin polymer (COP), and cycloolefin copolymer (COC).

The lens main body includes a light-condensing portion having a function of condensing light on one surface side and a plurality of detectable portions on the other surface side. The detectable portions are, for example, lines that extend along the length direction of the lens main body, and a stripe pattern is formed by the plurality of lines on the other surface side of the lens main body. The plurality of detectable portions are projected on the upper surface side of the lens main body as an optically detectable image and can be optically detected, for example.

The detectable portion needs only to be optically detectable, and may be a colored film, for example. The color of the colored film is not particularly limited, and may be black, for example. The colored film may be, for example, a coating film, and can be formed of a coating material. The coating material is not particularly limited, and may be a liquid coating material or a powder coating material, for example. The coating film can be formed by coating and/or solidifying the coating material, for example. The coating method may be, for example, spray coating, screen printing, or the like. The solidifying method may be, for example, drying of the liquid coating material, curing of a curable component (e.g., a radical polymerizable compound or the like) in the coating material, baking of the powder coating material, or the like.

The pattern formed by the detectable portions is by no means limited. For example, when the pattern is the above-described stripe pattern, the density of the color forming the stripe pattern may be uniform, or the stripe pattern may contain color gradations, for example.

When the marker 33 is placed on, for example, a white object, among light rays that have entered from the upper surface of the lens main body of the marker 33, the light rays that have reached the detectable portions are absorbed by the detectable portions (e.g., black colored films), and the other light rays pass through the lens main body and are reflected from the surface of the object. Accordingly, on the upper surface of the lens main body, images of the detectable portions (e.g., black lines) are projected onto a white background. Thus, in the marker unit 3, the interposed substrate 20 on which the marker 33 is arranged functions as a reflector, and therefore, for example, when the detectable portion of the marker 33 is formed in black, it is preferable that the upper surface of the interposed substrate 20 located below the marker 33 be white.

FIGS. 5A and 5B show an example of the marker unit 3 in which the marker 33 is mounted on the marker mounting unit 2 of FIG. 3, but the present embodiment is not limited thereto. FIGS. 5C and 5D are cross-sectional views of the marker unit 3 in which the marker 33 is mounted on the marker mounting unit 2 of FIG. 4. As shown in FIGS. 5C and 5D, in the marker unit 3, the marker 33 may be arranged on the interposed substrate 20 and in the marker arrangement region 101 of the upper substrate 10 of the marker mounting unit 2 of FIG. 4. Although it is not shown, for example, in the marker mounting unit 1 of FIGS. 1A and 1B, the marker 33 may be arranged on the lower substrate 11 and in the marker arrangement region 101 of the upper substrate 10.

### Fifth Embodiment

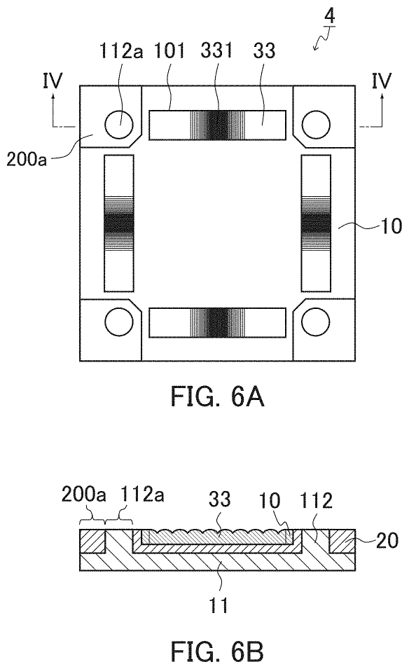

The fifth embodiment relates to, as another example of the marker mounting unit of the present invention, a variation of the marker mounting unit composed of three substrates as in the third embodiment. FIGS. 6A and 6B are schematic views of the marker mounting unit 4 of the present embodiment, FIG. 6A is a plan view, and FIG. 6B is a cross-sectional view taken along the line IV-IV of FIG. 6A.

As shown in FIG. 4, the marker mounting unit 2 according to the third embodiment is configured such that, on the upper surface side thereof, the entire periphery of the upper surface 112a of the bump 112 of the lower substrate 11 is surrounded by the upper surface 200a of the cylindrical portion 202 of the interposed substrate 20, and the entire periphery of the upper surface 200a is surrounded by the upper substrate 10. On the other hand, the marker mounting unit 4 according to the present embodiment is configured such that, on the upper surface side, the entire periphery of the upper surface 112a of the bump 112 of the lower substrate 11 is surrounded by the upper surface 200a of the cylindrical portion 202 of the interposed substrate 20, whereas the entire periphery of the upper surface 200a is not surrounded by the upper substrate 10.

Detection of the detection reference portion 112a on the upper surface of the bump 112 of the marker mounting unit 2 is generally performed by detecting the edge between the bump 112 and the substrate (interposed substrate 20 in FIGS. 6A and 6B) surrounding the entire periphery of the bump 112. Thus, in the case of a three-layer substrate, for example, the entire periphery of the substrate (interposed substrate 20) surrounding the entire periphery of the bump 112 is not necessarily surrounded by another substrate (upper substrate 10).

### EXAMPLES

### Example 1

A marker unit composed of a three-layer laminate shown in FIGS. 5C and 5D was produced, and the influence of shadows in the binarization process was examined. In the marker unit, the marker between the detection reference portions is a RAS marker.

As the upper substrate of Comparative Example A, a polycarbonate plate (product name: Iupilon S-3000R, Mitsubishi Engineering-Plastics Corporation) having a smooth surface with a thickness of 0.8 mm was used (upper substrate A). On the other hand, the substrates shown in Table 1 below were used as the upper substrates of Examples B to E. The upper substrate of each example was prepared by subjecting the upper substrate A used in the comparative example to the surface treatment shown in Table 1 below. The roughening treatment was performed by an electric discharge machining treatment, and the white coating treatment was performed by a coating treatment using a white paint (pigment) having high weather resistance.

TABLE 1

| | | Relative |
|---|---|---|
| | Upper substrate | transmittance % |
| Comparative | Upper substrate A | 100 |
| Example A | | |
| Example B | Upper surface of upper substrate A was | 98.0 |
| | subjected to roughening treatment | |
| Example C | Both surfaces of upper substrate A were | 85.5 |
| | subjected to roughening treatment | |
| Example D | Lower surface of upper substrate A was | 11.6 |
| | subjected to white coating treatment | |
| Example E | Upper surface of upper substrate A was | 11.6 |
| | subjected to white coating treatment | |

The relative transmittance of each of the upper substrates was calculated. First, each of the samples (the upper substrate A of the comparative example and the upper substrates of Examples B to E) was disposed between the light source of the spectrophotometer and the integrating sphere, the sample was irradiated with light in the visible light region while wavelength sweeping, and the amount of light of each wavelength received was detected by a detector in the integrating sphere. Among the detected light, the transmittance of light at a wavelength of 550 nm was determined as the measured transmittance. Then, the measured transmittance at a wavelength of 550 nm of the upper substrate A of the comparative example was set to 100%, and the relative value of the measured transmittance at a wavelength of 550 nm of each of the upper substrates of the Examples B to E was obtained, and this was set as the relative transmittance of each of the upper substrates of the examples B to E. For detecting the amount of light of the upper substrate, the upper substrate was used alone, and the surface that has been subjected to the surface treatment was irradiated with light in the visible light region. The calculation results of the relative transmittance of the upper substrate A of the comparative example and the upper substrates of each of Examples B to E are shown in Table 1.

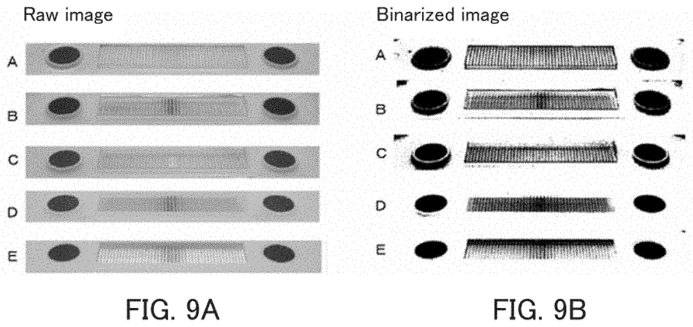

The camera was set at an angle inclined at +30° with the angle between the upper surface of the marker unit and the normal to the upper surface as 0°. Then, the marker units were photographed by the camera. Subsequently, from these raw images, binarized images were obtained. The results are shown in FIGS. 9A and 9B. FIG. 9A shows the raw images of the marker units photographed from the inclination angle, and FIG. 9B show the binarized images of the marker units obtained from the raw images.

In Comparative Example A, as shown in FIG. 9A, a shadow was caused by the bump of the lower substrate and the cylindrical portion of the interposed substrate covering the bump, and the shadow was observed in the raw image through the upper substrate. As shown in FIG. 9B, in the binarized image, not only the circular detection reference portion but also the shadow was converted into black, and the detection reference portion and the shadow were observed as one circular shape. It has been found that, based on this binarized image, the apparent detection reference portion is analyzed to be larger, deformed in shape, and off-center compared to the true detection reference portion, and therefore, the analysis accuracy is affected as a result. In contrast, the occurrence of shadow in Examples B to E was suppressed as compared to Comparative Example A in each of the raw images of FIG. 9A, and as a result, the change in the size, shape, and center of the apparent detection reference portion from the true detection reference portion was also suppressed in each of the binarized images of FIG. 9B. Specifically, in Examples B and C, as shown in FIG. 9B, although a black region is visible around the detection reference portion due to the shadow, a white line is also observed between the black region originating from the detection reference portion and the black region originating from the shadow. Since both are separated by a white line, unlike Comparative Example A, it can be said that the influence of shadow can be suppressed. Further, as shown in FIG. 9B, Examples D and E hardly show black regions originating from shadows. Therefore, it has been found that, according to each example, the influence of shadow can be suppressed and the analysis accuracy can be improved.

### INDUSTRIAL APPLICABILITY

As described above, according to the marker mounting unit of the present invention, the detection reference portion can be accurately detected by setting the relative transmittance at the periphery of the through hole of the upper substrate on at least one surface as described above.

This application claims priority from Japanese Patent Application No. 2017-037956 filed on Mar. 1, 2017. The entire subject matter of the Japanese Patent Application is incorporated herein by reference.

### REFERENCE SIGNS LIST

1, 2, 4: marker mounting unit
3, 5, 6: marker unit
10, 40: upper substrate
11, 41: lower substrate
20, 42: interposed substrate
101, 401: marker arrangement region
112: bump
202: cylindrical portion
33, 43: marker
331, 431: image

1. A marker mounting unit comprising:
a lower substrate; and
an upper substrate, wherein
the marker mounting unit is a laminate in which the upper substrate is laminated on the lower substrate,
the lower substrate has a bump serving as a detection reference portion,
the upper substrate has a through hole at a position corresponding to the bump of the lower substrate,
the bump of the lower substrate is inserted into the through hole of the upper substrate, and
the upper substrate has a relative transmittance of 99% or less at least at a periphery of the through hole on at least one surface.

2. The marker mounting unit according to claim 1, wherein
the upper substrate is a transparent substrate in which at least the periphery of the through hole is roughened at least on one surface.

3. The marker mounting unit according to claim 2, wherein
the upper substrate is a transparent substrate in which at least the periphery of the through hole is roughened on both surfaces.

4. The marker mounting unit according to claim 1, wherein
the upper substrate has a relative transmittance of 30% or less at least at the periphery of the through hole on at least one surface.

5. The marker mounting unit according to claim 1, wherein
the upper substrate is a transparent substrate having a white film at least at the periphery of the through hole on at least one surface.

6. The marker mounting unit according to claim 5, wherein
the upper substrate is a transparent substrate having a white film at least at the periphery of the through hole on both surfaces.

7. The marker mounting unit according to claim 1, wherein
the bump of the lower substrate has a black upper surface.

8. The marker mounting unit according to claim 1, wherein
the laminate further comprises an interposed substrate,
the lower substrate, the interposed substrate, and the upper substrate are laminated in this order,
the interposed substrate is a substrate having a through hole at a position corresponding to the bump of the lower substrate, and
the bump of the lower substrate is inserted into the through hole of the interposed substrate and the through hole of the upper substrate.

9. The marker mounting unit according to claim 1, wherein
the laminate further comprises an interposed substrate,
the lower substrate, the interposed substrate, and the upper substrate are laminated in this order,
the interposed substrate is a substrate having a through hole at a position corresponding to the bump of the lower substrate and having a cylindrical portion protruding upward at the periphery of the through hole,
the through hole on the upper substrate corresponds to the bump of the lower substrate and the cylindrical portion of the interposed substrate,
the bump of the lower substrate is inserted into a through hole in the cylindrical portion of the interposed substrate, and
the cylindrical portion of the interposed substrate is inserted into the through hole of the upper substrate.

10. The marker mounting unit according to claim 8, wherein
the interposed substrate has a white upper surface.
